(19) United States
(12) Patent Application Publication
(10) Pub. No.: US 2026/0239513 A1
(43) Pub. Date: Aug. 13, 2026

(54) Door Hanging Flexible LED

(71) Applicant: Innovation Works, Inc., Short Hills, NJ (US)

(72) Inventor: Joshua Scharf, Short Hills, NJ (US)

(73) Assignee: Innovation Works, Inc., Short Hills, NJ (US)

(21) Appl. No.: 19/181,408

(22) Filed: Apr. 17, 2025

Related U.S. Application Data
(60) Provisional application No. 63/635,620, filed on Apr. 18, 2024.

(51) Int. Cl. H05B 47/13; F21V 23/00; F21W 111/00; F21Y 115/10; G09F 13/04; H05B 47/16

(52) U.S. Cl. CPC H05B 47/13; F21V 23/005; G09F 13/045; H05B 47/16; F21W 2111/00; F21Y 2115/10

(57) ABSTRACT

A simple, cost effective, easily identifiable landmark for dark or low-light environments is disclosed, which helps orient and safeguard otherwise disoriented individuals. The landmark can be a device that includes a motion detector, a light sensor, a factory-installed non-serviceable battery, and one red LED light. The product can be hung on an available architecture fixture, such as a doorknob, a cabinet, and the like that is within a reasonable range of where an individual is likely to walk. When motion is detected within a short range, such as 3-4 feet, under low-light conditions, the red LED light is triggered to “ON” for a short duration, such as 10-15 seconds. The brief time is sufficient for the individual to note the location of the red LED light, which helps that person orient on their location within the environment.

### CROSS-REFERENCE TO RELATED APPLICATIONS

This application is a U.S. Non-Provisional Utility Patent Application entitled, “Door Hanging Flexible LED” which claims priority to co-pending U.S. Provisional Patent Application No. 63/635,620, filed on Apr. 18, 2024 entitled, “Door Hanging Flexible LED” the contents of which are hereby fully incorporated by reference.

### FIELD OF THE EMBODIMENTS

The field of the invention and its embodiments relate to a door hanging flexible LED, and more specifically, to a low-light spatial landmark for hallways and similar environments, suitable for being positioned and hung on doorknobs and similar objects.

### BACKGROUND OF THE EMBODIMENTS

Older individuals, people with reduced cognitive abilities, and others regularly experience disorientation during low-light and nighttime conditions. This disorientation is exasperated when these individuals are in temporary or unfamiliar environments, as well as when awaking from sleep. Similar problems occur during unexpected power outages that plunge an environment into darkness. To elaborate, it is common for some individuals to wake up at night and feel confused and bewildered, not knowing where they are. This disorientation upon awaking occurs both when the individual is in their home or elsewhere, such as visiting family, staying in hotels, traveling, and the like. Also during emergent situations such as a fire, dense smoke conditions, earthquakes, and other conditions that may confuse inhabitants when they need to find rapid egress from a building. Disorientation can lead to panic, mental distress, and physical injury. That is, it is common for a disoriented individual to start moving around, in low light, within an unfamiliar environment, which can lead to tripping, falling down stairways, and the like.

What is needed is a low-level spatial landmark, preferably a portable one or one easily installed at low cost, which minimizes disorientation risks, including unnecessary emotional distress and physical injury. Ideally, the low-level spatial landmark will be minimally intrusive to others sharing the environment. For example, although night-lights and other mechanisms are helpful in situations, constrained of being positioned near a wall outlet and/or requiring active electric power, and can be relatively bright to a displeasure of others in an environment that prefer relatively full darkness when sleeping.

### SUMMARY OF THE EMBODIMENTS

One aspect of the disclosure is for a simple, cost effective, easily identifiable landmark for dark and/or low-light environments, which helps orient and/or safeguard otherwise disoriented individuals. The landmark may be a device that includes a motion detector, a light sensor, a factory-installed non-serviceable battery, and/or at least one red LED light. The product may be hung on an available architecture fixture, such as a doorknob, a cabinet, and the like that is within a reasonable range of where an individual is likely to walk. When motion is detected within a short range, such as 3-4 feet, under low-light conditions, the red LED light is triggered to “ON” for a short duration, such as 5-15 seconds. The short time is sufficient for the individual to note the location of the red LED light, which helps that person orient on their location within the environment.

A notable feature of the embodiment is a paper pull to activate and engage the factory-installed battery. This is to maintain the battery during dormant storage of the product and to engage the product only when deployed.

In some embodiments, use of the red LED light is preferable as research has shown that exposure to red light may improve sleep. Exposure to red light during sleep and upon waking may reduce a likelihood of feeling tired and disoriented, which is sometimes referred to as sleep inertia. Thus, an individual triggering the light inadvertently or accidentally, will generally not adversely affect their sleep cycle or that of others in proximity. In other embodiments, a yellow or orange LED light may be alternatively used for similar purposes. Embodiments are contemplated where multiple devices, having different colored lights, may be utilized in conjunction with each other to convey color-sensitive meanings. That is, it could be preferably to utilize a yellow or orange LED light containing device near stairways or other hazards, where using a red LED light otherwise.

In some embodiments, the landmark device may be formed from a relatively lightweight, flexible material. Preferably, the material may be low-cost, heat-sealable to minimize manufacturing costs, printable, and at least partially transparent so that the sensors and light may penetrate the transparent skin of the device. Various plastics may be used as a main material, such as Acrylonitrile Butadine Styrene (ABS) or Polyetheylene terephthalate (PET). Moreover, the landmark device may be relatively small, measuring approximately 4″ by 2.5″ in embodiments. The material of the device may be shaped with an integrated hook within an internal structure. A stiffening or reinforcing element may be utilized to strengthen the hook portion.

One aspect of the disclosure is for a light emitting device including a fold-flat foil bag, and an active component compartment. The fold-flat, foil bag is configured to be fitted over and hung upon a doorknob. The active component compartment is one within the foiled bag, which has a transparent sensor window. The active component compartment includes a LED emitter, a battery, a motion detector, and a light sensor. The light emitting device is configured to detect motion of a person within five feet, or less, during dim lighting conditions and responsive to detecting the motion is further configured to turn on the LED emitter for a short duration. The short duration is less than a minute, such as being between five and thirty seconds. After the short duration, the LED emitter automatically turns off until reactivated via another instance of motion detection.

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings indicates similar or identical items.

FIG. 1A is a diagram illustrating a light emitting device, in accordance with some embodiments.

FIG. 1B is a diagram illustrating packaging for the device of FIG. 1A, in accordance with some embodiments.

FIG. 2 is a front plan view of an example of the light emitting device of FIG. 1A, in accordance with some embodiments.

FIG. 3 is a top perspective view of the light emitting device of FIG. 2, in accordance with some embodiments.

FIG. 4 is a bottom perspective view of the light emitting device of FIG. 2, in accordance with some embodiments.

FIG. 5 is a front plan view of an example of the light emitting device of FIG. 1A with surface indicia disposed thereon, in accordance with some embodiments.

FIG. 6 is a side plan view of the light emitting device of FIG. 5 with a housing disposed thereon, in accordance with some embodiments.

FIG. 7 is a rear plan view of the light emitting device of FIG. 5 with a power source retained in the housing, in accordance with some embodiments.

FIG. 8 is an exploded view of the light emitting device of FIG. 5 with at least a portion of the circuitry configured to be retained in the housing, in accordance with some embodiments.

FIG. 9 is an exploded view of the light emitting device of FIG. 5 with one or more sensors each aligned with an opening of a cover of the housing and at least one sensor protruding through one of the openings, in accordance with some embodiments.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

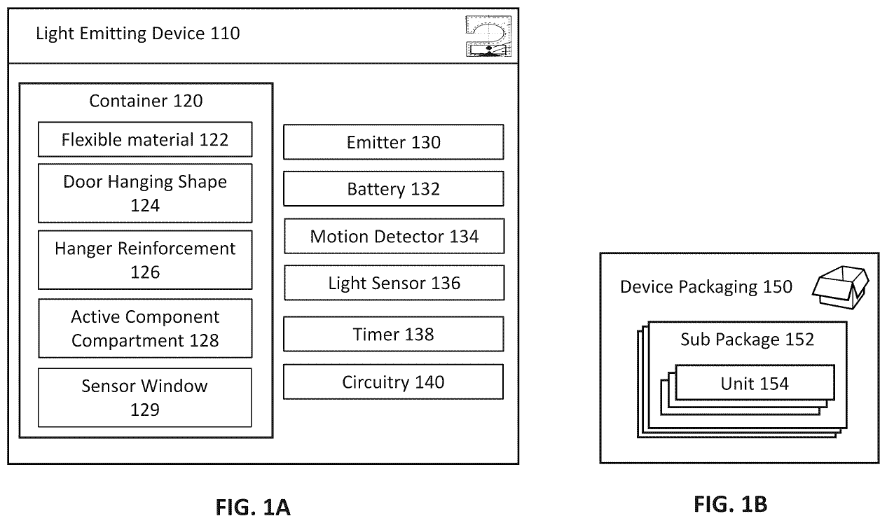

FIG. 1A illustrates a diagram of a door hangable landmark device, also referred to interchangeably as alight emitting device 110. Unlike a flashlight, night light, reading light, and the like, light emitting device 110 is configured to function as a low-light spatial landmark. As such, the light emitter 130 is configured provide a relatively low-level of illumination able to be visually seen in a low-light or dark environment. Light emitter 130 may not provide levels of light to enhance visibility of a surrounding area, but instead provides just enough light to function as an indicator of a point in space. The low-level of power provided by light emitter 130 minimizes disorientation that may occur when a human's eyesight must adjust from a dark to a more well-lit environment. The light emitting device 110 may possess a hanging shape 124 or may otherwise include an integrated hanging component, which enables light emitting device 110 to be selectively supported by a doorknob, a cabinet handle, a rail of a stairway, and the like.

In embodiment, light emitting device 110 operates without external power, as power is provided by battery 132. In a preferred embodiment, battery 132 is a non-replaceable, self-contained one that powers electronic components of light emitting device 110, including light emitter 130, motion detector 134, light sensor 136, timer 138, and/or circuitry 140, for approximately 2 to 3 years after which time the light emitting device 110 is to be disposed. Preferably, emitter is a red Light Emitting Diode (LED), but other colors and types of emitters, such as yellow and orange ones, are within scope of the disclosure. Use of a red LED is sufficiently visible, have been found to increase production of melatonin, and exposure to red light reduces a likelihood of sleep inertia being induced by light emitter 130.

Light emitter 130 may typically be in an inactive or non-emitting state, which changes when light sensor 136 indicates a low-light condition exists and when motion detector 134 detects motion consistent with movement of a human being proximate to the light emitting device 110. Timer 138 provides a time-out period for triggered emissions of light emitter 130. In a preferred embodiment, the detection range of the motion detector 134 is relatively short, such as being three to four feet. Preferably, timer 138 ensures the on state of light emitter 130 persists for a relative short duration sufficient for serving as a spatial landmark, such as emitting for ten to twenty seconds. The circuitry 140 interconnects other components 130-138 and facilitates their operation. In a preferred embodiment, components 130-140, or a majority of them, are integrated within a relatively small printed circuit board (PCB).

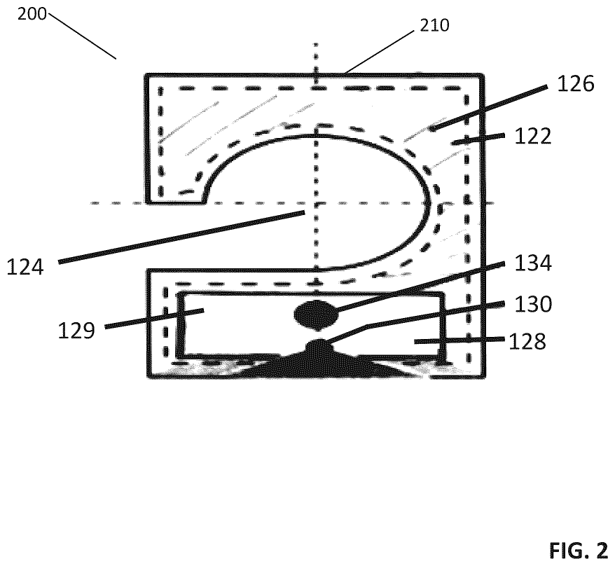

In one embodiment, the components 130-140 are contained within an active component compartment 128 of container 120, which may be constructed of a flexible material 122. The flexible material 122 can form an exterior skin of the light emitting device 110. Preferably, material 122 is a low-cost, heat-sealable, printable, transparent, or semi-transparent material. Preferably, the flexible material 122 itself may form the handing shape 124. A hanger reinforcement 126 can strengthen a region proximate to the hanging shape 124 to ensure sufficient stiffness and structural support (e.g., to support weight of light emitting device 110 when hung). While a portion of container 120 can be frosted, textured, branded, printed, or treated with an opaque coloring for aesthetic purposes, a sensor window 129, which may be formed from the same flexible material 122, is transparent and is substantially clear of light-blocking obstructions. Sensor window 129 can be a sidewall of active compartment 128, which contains at least components 130, 134, and/or 136. Sensor window 129 ensures components 130, 134, and/or 136, which require conveyances of electromatic emissions in the visible range (e.g., light) passes through window 129 occur. In embodiment, sensor window 129 can be directional in that only movement or light-level in a specific direction is detected and where light emissions other than that direction are blocked or inhibited. In embodiments, container 120 is a bag-like, foldable device having a modest form factor, such as being 4″ by 2.5″ as shown in FIG. 2. The foldable nature of light emitting device 110 simplifies packaging and storing of the light emitting device 110, as the light emitting device 110 can be folded to be relatively flat.

FIG. 1B illustrates a packaging configuration for a plurality of light emitting devices, such as light emitting device 110 described in FIG. 1A. A rectangular packaging 150 suitable for shipping (e.g., a box) may retain multiple subpackages 152, which contain multiple units 154 of light emitting device 110. Subpackages 152 may be a defined commercially sold grouping of a set of light emitting devices 110, such as a twelve pack of unit 154.

In some embodiment, the illustrated system includes a device packaging 150, which is a container or box configured to hold multiple units of the disclosed low-light spatial landmark device for purposes of shipping, storage, or retail sale. The device packaging 150 may be constructed of cardboard, corrugated paper, or another suitable rigid material. In one embodiment, packaging 150 may comprise a rectangular corrugated carton, such as a 12 inch×10 inch×12 inch box. Within the device packaging 150 are multiple sub-packages 152, each of which contains a group of individual light emitting units 154. Each sub-package 152 may be implemented as a polybag, foil pouch, or paper sleeve, and is configured to contain a defined quantity of the spatial landmark devices, e.g., twelve units 154 per sub-package. These sub-packages allow for efficient bundling and handling of the devices, such as for bulk distribution or institutional use.

Each unit 154 corresponds to a single self-contained spatial landmark device also referred to interchangeably as light emitting device 110 (as described in FIG. 1A), including its housing, light emitter, sensors, power source, and circuitry. In preferred embodiments, each unit 154 has a compact and foldable form factor, for example, measuring approximately 80 mm×120 mm in flat configuration, allowing the units to be densely packed and shipped efficiently. The packaging configuration of FIG. 1B may be particularly well-suited for commercial applications and promotional distribution, wherein large quantities of the devices are shipped to organizations such as elder care facilities, sleep clinics, or hospitality venues. The packaging system ensures that the foldable, lightweight design of the devices is leveraged for reduced shipping volume and improved storage logistics. In some embodiments, the sub-packages 152 may be labeled or barcoded, and the outer packaging 150 may include product information, instructions for use, regulatory notices, and branding elements. Optional protective features, such as desiccants or internal trays, may be included to preserve device integrity during transport. Thus, FIG. 1B illustrates a modular, scalable, and low-cost packaging system for high-volume distribution of spatial landmark light-emitting devices, enhancing their deployability across a wide range of use cases.

FIG. 2 illustrates an example of the light emitting device of FIG. 1A, designated as light emitting device 200, that may comprise any shape including, but not limited to, a rectangular shape front and rear portion, an oval shape, and/or a radiused shapewhich has a carved out center or a substantially radiused opening representing hanging shape 124. Thus, light emitting device 200 can fit around a doorknob and be self-supporting. In certain embodiments, circuitry of the light emitting device 200 may be enclosed in a rectangular-shaped pouch having a gusseted construction. The pouch may have opposing front and rear faces joined along side seams, with a bottom and/or top gusset formed by folding an additional panel of flexible material inward between the front and rear faces. The gusset allows for expansion of the pouch volume when filled or pressurized, while maintaining a generally flat configuration when not in use.

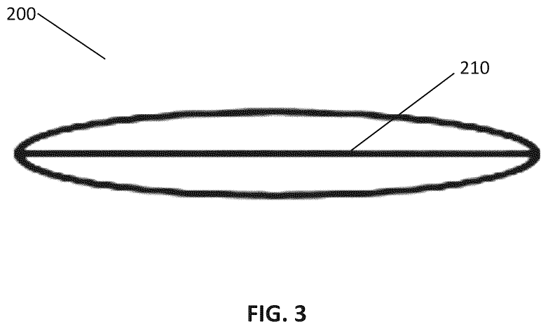

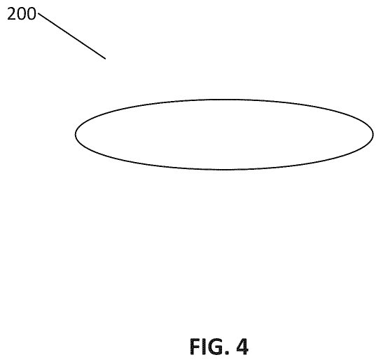

Although the front and back views of the pouch present a substantially rectangular shape, the top view (FIG. 3) and bottom view (FIG. 4) of the pouch may exhibit an oval or elliptical appearance. This visual effect arises from the curvature introduced by the folded gusset panel, which causes the top and bottom edges to bow outward slightly along their horizontal axis. When viewed from above or below, the combination of these outward curves creates an oval-like silhouette, particularly when the pouch is inflated or contains internal components that apply outward pressure. In preferred embodiments, the gusset is heat-sealed or bonded along its edges to maintain structural integrity and to enclose internal electronic components of the device. The oval appearance from the top and bottom views contributes to the aesthetic profile of the device and may assist in its ability to conform to a hanging orientation or accommodate ergonomic gripping and installation.

Although specifics of the light emitting device 200 may change from implementation to implication, details of a preferred embodiment as expressed in FIG. 2 are enlightening. In one embodiment, light emitting device 200 is a printable foiled bag 122 with a hook shape 125 reinforced by a PET sheet 126 placed between the foiled bag 122 to reinforce the hanging position. In one embodiment, the light emitting device 200 is about 80 mm by 120 mm per single side. Each light emitting device 200 can be considered a unit 154, where twelve units 154 are able to be placed within a big polybag 152. Eight polybags 152 can be placed in a carton 154, which can be 12×10×12 inch carton made of corrugated paper. Components 130-140 can be placed on a single sided PCB about 30 mm by 40 mm. A single RED LED light 130 can be utilized, as can one 23A 12V alkaline battery, which is non-replaceable and sealed within compartment 128. A passive infrared (PIR) sensor can be used to detect motion 134 and sense light levels 136. In one embodiment, the PIR sensor can be approximately 8 mm in size, can have a Fresnel lens with a focal length of 8 mm, an angle of approximately 140 degrees, and a distance of approximately 6M.

As can be seen, a low-cost design (with reference to FIG. 2), which is able to be folded flat for packing and storage is contemplated. The light emitting device 110 is made of materials able to be easily printed upon, so is able to be easily distributed as a highly useful promotional item, which is of particular interest to numerous organizations, including but not limited to: AARP, hotel chains, pharmaceutical companies promoting products targeted at reducing disorientation, senility, dementia, psychiatric service providers, sleep apnea treatment centers, and the like.

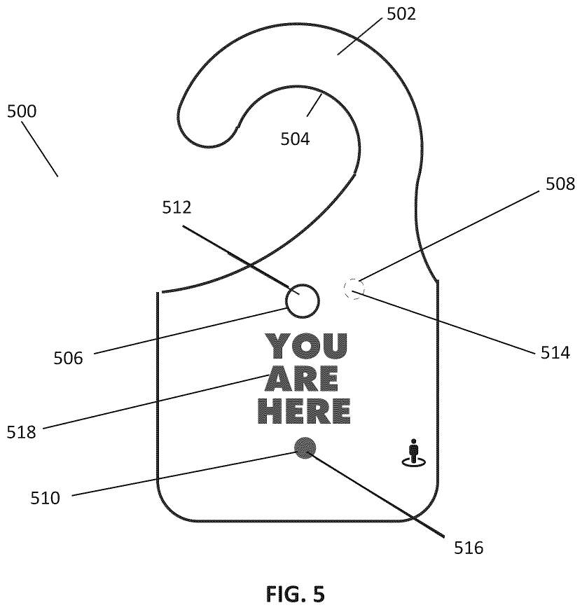

FIG. 3 illustrates a top view of the light emitting device 200 of FIG. 2, which may correspond to the light emitting device 110 previously described in FIG. 1A, in accordance with embodiments of the present disclosure. In the illustrated embodiment, the light emitting device 200 is shown to have a generally oval or elliptical shape when viewed from above. This top view highlights the compact and symmetrical form factor of the device, which is designed to be minimally obtrusive and aesthetically neutral for use in household, healthcare, or travel environments. The outer perimeter of the oval-shaped structure represents the peripheral edge of the housing or flexible container enclosing the internal components of the device. The longitudinal axis of the ellipse likely corresponds to the longest dimension of the device, which may be, for example, approximately 120 mm in length, while the shorter axis may measure approximately 80 mm in width, consistent with previous packaging and dimensional disclosures. In some embodiments, this top view may correspond to the top surface 210 shown in FIGS. 2 and 3, and may be formed from flexible printable material 122, including surface indicia 518 (FIG. 5) including, but not limited to, branding and/or instructions for use. The overall form is low-profile and smooth, enabling it to be hung easily and to avoid snagging or discomfort when suspended from a doorknob or similar structure.

The elliptical shape may also serve to facilitate uniform light diffusion from the emitter through the housing material, particularly when a red LED or similar low-power emitter is centrally located within the active component compartment 128 underneath this top-facing surface. The top view does not reveal the internal components but instead emphasizes the external appearance of the device in its operative orientation. As such, the internal emitter, motion detector, light sensor, and battery (see FIG. 1A) are located beneath this visible surface and may be arranged symmetrically within the internal compartment of the housing.

FIG. 4 is a bottom perspective view of the light emitting device 200, which corresponds to the embodiment of the light emitting device shown in FIG. 2 and described in connection with FIGS. 1A and 3, in accordance with some embodiments of the present disclosure. The light emitting device 200 may feature a generally elliptical or oval profile when viewed from the underside. The device may include a flexible outer housing formed from a heat-sealable or laminated film material, such as printable polymer foil or coated plastic sheet. The housing may enclose the internal electronic components including, but not limited to, a light emitter, a motion detector, a light sensor, a battery, a timer, and/or circuitry components, as described in at least FIG. 1A. In the illustrated embodiment, the housing may incorporate one or more gusseted regions, which are foldable expansions built into the sidewalls of the device. These gussets enable the device to collapse into a flattened configuration when packaged or stored, and to expand into an operative three-dimensional form when deployed or hung. In one embodiment, the gussets are heat-creased along predefined fold lines, allowing them to naturally fold inward under light pressure and unfold when suspended.

The bottom surface visible in FIG. 4 may comprise one panel of a two-layer laminate structure joined by a peripheral seal or seam. The gussets are positioned between the front and back flexible panels and may be shaped to define the depth of the internal active component compartment when expanded. The gusseted construction supports the formation of an internal cavity sufficient to house the printed circuit board (PCB) and other active elements, while maintaining a minimal profile when collapsed. The flat-folding capability enabled by gussets is advantageous for manufacturing and logistics. For example, it allows multiple units of the device to be stacked and grouped into sub-packages (as shown in FIG. 1B), conserving space during bulk shipping. Upon deployment, the expanded gusseted structure provides adequate volume and mechanical support for reliable operation of the sensor and emitter elements. Additionally, the gussets may serve a secondary optical function, such as acting as internal light reflectors or baffles to direct or diffuse light emitted from the red LED, minimizing unwanted glare or spillage of light outside the target emission zone.

FIG. 5 illustrated another embodiment of a light emitting device 500, corresponding to the light emitting device 110 of FIG. 1A, in accordance with some embodiments of the present disclosure. The light emitting device 500 is configured as a low-light spatial landmark and includes a hanging structure designed for suspension from an architectural fixture, such as a doorknob, cabinet handle, and/or similar feature. The device 500 comprises a hanging member 502, which defines the general shape and structural configuration of the device. In some embodiments, the hanging member 502 is formed from a rigid or semi-rigid substrate material, such as chipboard packing material, coated or laminated with printed graphics or a protective film. The hanging member 502 includes a substantially radiused edge 504 defining a hook-shaped profile configured to permit suspension of the device in a hanging orientation. The curved contour of the edge 504 facilitates engagement with cylindrical or spherical knobs and supports gravitational alignment of the device in use.

The hanging member 502 further includes multiple apertures or openings configured for alignment with corresponding internal components. A first opening 506 is disposed through the hanging member and is positioned to be aligned with a motion sensor 512 positioned within the interior of the device housing. The motion sensor 512 may comprise a passive infrared (PIR) sensor configured to detect thermal movement in the vicinity of the device. A second opening 508 is also formed through the hanging member 502, aligned with a light sensor 514 located within the housing. The light sensor 514 is configured to detect ambient light levels and may be used to determine whether low-light conditions exist to activate the emitter. In some embodiments, one or both of the openings 506 and 508 may be covered with a transparent or semi-transparent window layer to protect internal components while allowing transmission of infrared and/or visible light.

A third opening 510 is located near a lower portion of the hanging member 502 and is aligned with a light emitter 516 disposed inside the housing. The light emitter 516 may be implemented using a red light-emitting diode (LED) or another low-intensity light source configured to produce localized illumination sufficient to act as a positional landmark without significantly illuminating the surrounding area. Disposed on a surface of the hanging member 502 is surface indicia 518, which may include branding, instructions, directional text, or other visual content. In the illustrated embodiment, the indicia includes the phrase “YOU ARE HERE,” providing contextual or wayfinding information to users. The surface indicia 518 may be printed, embossed, laminated, or otherwise formed on the exterior of the device housing.

In various embodiments, the light emitting device may include one or more sensor components configured to detect environmental conditions that trigger or govern the operation of the light emitter. The sensor subsystem may include, but is not limited to, a motion sensor, a light sensor, and optionally, additional sensors such as temperature, proximity, or directionality sensors. A motion sensor may be disposed within the active component compartment of the device and operatively coupled to a controller or timing circuit. In a preferred embodiment, the motion sensor is implemented as a passive infrared (PIR) sensor, which is configured to detect movement of warm bodies—such as humans or animals—based on variations in infrared radiation. The PIR sensor may comprise a pyroelectric element housed within a Fresnel lens assembly to focus infrared radiation across multiple zones of detection. In one embodiment, the Fresnel lens has a focal length of approximately 8 mm, a detection angle of approximately 140 degrees, and a range of 3 to 6 meters. The sensor generates an electrical signal in response to motion, which is processed by onboard circuitry to determine whether activation criteria for the emitter are met. The motion sensor may be positioned such that it aligns with a corresponding opening or light-transmissive window in the housing or hanging member, ensuring unobstructed detection of motion. In some embodiments, directional PIR sensors may be used to limit detection to one side of the device, reducing false triggering from irrelevant motion sources.

A light sensor is included in the device and configured to detect ambient light levels. The light sensor may be implemented using a photodiode, phototransistor, or light-dependent resistor (LDR), which varies output in proportion to the intensity of incident light. In a preferred embodiment, the light sensor is configured to detect low-light or dark conditions, such as night-time indoor environments, and may define a threshold below which the emitter can be activated. The light sensor is electrically coupled to a timing circuit or control logic that receives input signals and evaluates whether the sensed ambient light falls below a predefined threshold value. In some embodiments, when the light level is below the threshold, and in conjunction with a motion detection event, the control circuit activates the light emitter. The light sensor may be mounted adjacent to the motion sensor on a common printed circuit board and aligned with a separate opening or window in the housing, typically constructed from a transparent or semi-transparent material to allow accurate light level sensing.

In some embodiments, the sensors are functionally integrated through a control circuit or microcontroller unit (MCU), which interprets inputs and determines whether activation conditions are met. The system logic may implement an AND-gate configuration, such that the emitter is only activated when both a motion event and a low-light condition are concurrently detected. The use of both motion and light sensors enables power conservation and ensures that the light-emitting function operates only when needed. Additionally, a timer circuit may be coupled to the control logic to deactivate the emitter after a predefined time interval, such as 10 to 20 seconds, thereby further preserving battery life. In optional embodiments, the sensor system may be augmented with additional sensing capabilities such as proximity sensors, tilt sensors, or ambient temperature sensors, depending on use-case requirements. However, in preferred embodiments, the PIR motion sensor and ambient light sensor form the primary detection components of the system.

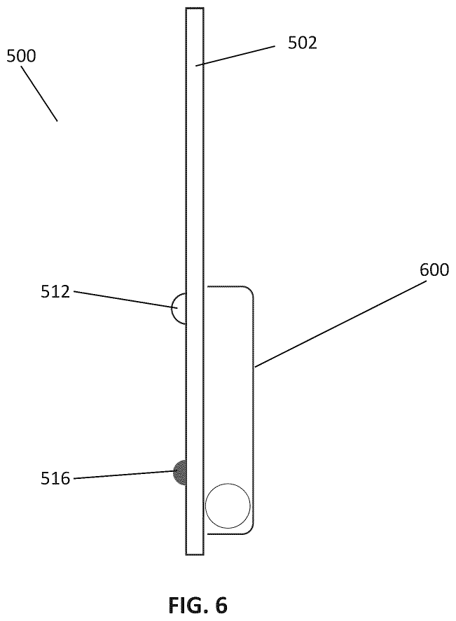

FIG. 6 illustrates the light emitting device 500, which corresponds to the front plan view of FIG. 5, in accordance with some embodiments of the present disclosure. The side view depicted in FIG. 6 illustrates the relative positioning of the hanging member 502 and a housing 600, which encloses the electronic components of the device. In the illustrated embodiment, the hanging member 502 is a substantially planar structure having a first side and an opposite second side. The hanging member 502 may be constructed from a flat sheet of semi-rigid material, such as chipboard or a laminated polymeric substrate, and defines the overall shape of the device for suspension on a doorknob or similar architectural fixture.

One or more sensors, including the motion sensor 512 and the light emitter 516, are mounted on or adjacent to the first side of the hanging member 502. These components are visible from the exterior of the device and may be aligned with respective openings in the hanging member 502, as described in connection with FIG. 5. The motion sensor 512 may comprise a passive infrared (PIR) sensor, while the emitter 516 may be a red LED or other low-intensity light source. The housing 600 is disposed on the second side of the hanging member 502. The housing 600 defines an enclosed compartment that retains additional internal components, including a printed circuit board (PCB), battery, light sensor, timer circuitry, and associated wiring. The housing 600 may be formed from molded plastic or laminated flexible material and may be secured to the hanging member 502 by adhesive bonding, mechanical fasteners, or ultrasonic welding.

The housing 600 is offset from the plane of the hanging member, defining a discrete active component compartment that provides volumetric space for component integration while maintaining a minimal profile when viewed from the front. In some embodiments, the housing 600 may include internal features such as alignment posts, standoffs, or partitions for organizing and protecting the electronics. The positional arrangement of the sensors and emitter on the first side of the hanging member 502, combined with the offset housing 600 on the second side, facilitates functional separation of sensing and control components while allowing the device to present a visually flat and user-facing front profile. This arrangement enables reliable performance while maintaining manufacturability and mechanical simplicity.

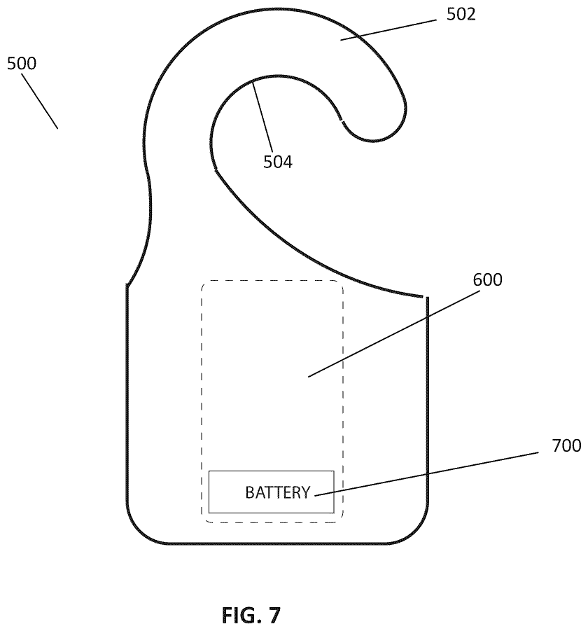

FIG. 7 illustrates the light emitting device 500, as previously illustrated in FIG. 5, in accordance with embodiments of the present disclosure. The view in FIG. 7 shows the rear side of the light emitting device 500 and reveals the spatial relationship between the hanging member 502, a housing 600, and a power source 700. The device 500 includes a hanging member 502 that defines the structural outline of the device and includes a radiused hook-shaped portion 504 for supporting the device in a suspended orientation. This rear view corresponds to the second side of the hanging member 502, opposite the first side shown in FIG. 5, where sensor and emitter components are exposed.

Mounted on the rear side of the hanging member 502 is the housing 600, which forms a compartment for retaining internal electronic components. The housing 600 may be fabricated from a molded polymeric material, a sealed pouch, or a multi-layer laminated substrate. It is configured to enclose and protect circuit elements necessary for the operation of the device, including the power source 700. The power source 700 is disposed within the housing 600 and electrically coupled to the emitter, motion sensor, light sensor, and timer circuitry housed within the same compartment. In one embodiment, the power source 700 comprises a non-replaceable, sealed battery, such as a 23A 12V alkaline battery. The battery may be permanently enclosed within the housing to provide a fixed operational lifespan of approximately 2 to 3 years, after which the device may be discarded or recycled. The power source 700 may be retained in the housing 600. The battery is preferably mounted near the lower portion of the housing to contribute to gravitational stabilization of the device when hung. The configuration depicted in FIG. 7 illustrates the functional division between the sensor/external components on the front-facing side and the power/control components housed on the rear side, thereby optimizing both user-facing visibility and internal electronic organization.

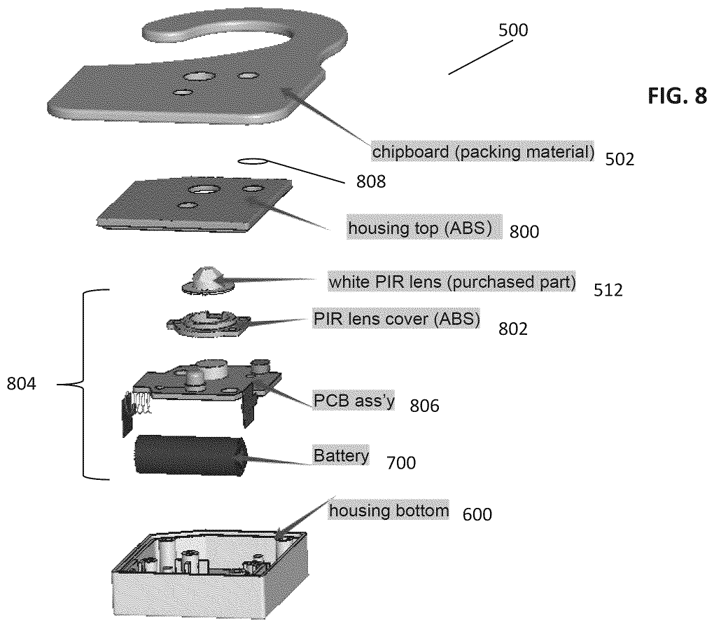

FIG. 8 illustrates the light emitting device 500, showing the relationship between external structural components and internal electronic assemblies, in accordance with the embodiment of FIG. 5. In particular, FIG. 8 depicts how at least a portion of the circuitry 804 is retained within a housing 600 affixed to the rear side of the light emitting device 500. At the top of the exploded view, the hanging member 502 is shown, which is formed from chipboard or similar printable packing material. The hanging member 502 defines the planar outline and suspension geometry of the device and includes openings aligned with sensor and emitter components disposed on or beneath it. Beneath the hanging member 502 is a housing top cover 800, formed from ABS (acrylonitrile butadiene styrene) or a similar molded plastic material. The housing top 800 contains through-holes or recesses for aligning optical components such as the motion sensor. A white PIR lens 512, which may be a pre-fabricated commercial optical component, is positioned beneath the top cover and configured to receive infrared radiation from the ambient environment. The PIR lens 512 may be secured in place by a PIR lens cover 802, also formed of ABS, which provides mechanical alignment and protection for the lens. Together, these components form part of the motion detection assembly.

Below the sensor optics is the PCB assembly 806, which is a printed circuit board configured to support and interconnect various electronic components, including the motion sensor, light sensor, light emitter (e.g., red LED), control circuitry, and timer logic. The PCB assembly 806 is one of the primary components of the circuitry 804, and is mounted within the interior of the housing 600. Electrically coupled to the PCB is a battery 700, which provides power for the device. In one embodiment, the battery 700 is a sealed, non-replaceable 12V alkaline cell. The PCB and battery are arranged in a stacked configuration and are collectively housed within a housing bottom 600, which defines the structural enclosure for the electronic subsystem. The housing bottom 600 is dimensioned to accommodate the PCB and battery in a compact form factor and may include internal bosses, clips, or partitions to retain and protect the components. It may also be coupled to the housing top 800 using adhesive bonding, ultrasonic welding, snap-fit tabs, or fasteners.

The assembly shown in FIG. 8 illustrates how the circuitry 804, including the PCB assembly 806, power source 700, sensor elements, and structural optics, is retained within the enclosed housing 600, which is mounted to the rear side of the hanging member 502 as shown in prior figures (e.g., FIG. 7). This modular construction enables compact integration, ease of manufacturing, and consistent alignment of components while isolating the functional electronics from the user-facing surfaces of the device. The exploded view also supports claim support for modular assembly, optical alignment, and rear-mounted electronics housing.

In some embodiments, one or more of the openings formed in the hanging member of the low-light spatial landmark device, namely, the first opening aligned with a motion sensor, the second opening aligned with a light sensor, and the third opening aligned with a light emitter, may be covered by a light-transmitting layer of material 808. This light-transmitting layer of material 808 may be composed of a transparent or semi-transparent polymeric material, such as polycarbonate, polyethylene terephthalate (PET), or acrylic. The light-transmitting layer of material 808 may be applied or affixed to the surface of the housing using lamination, adhesive bonding, or ultrasonic welding. The light-transmitting layer of material 808 is configured to permit transmission of electromagnetic radiation between the internal component and the external environment, such as infrared signals to and from the motion sensor, ambient visible light to the light sensor, or visible light emission from the LED. In addition to optical functionality, the light-transmitting layer of material 808 may serve to protect the internal electronics from dust, debris, and moisture, thereby improving environmental durability and product longevity.

In further embodiments, at least one of the motion sensor, the light sensor, or the light emitter may be configured to protrude through the corresponding opening in the hanging member. For instance, a passive infrared (PIR) sensor may include a dome-shaped Fresnel lens that extends outward through the first opening, enabling a wide field of detection and minimizing obstruction by the housing material. Similarly, the light sensor may extend partially through the second opening to improve exposure to ambient lighting conditions. The light emitter, such as a red LED, may also protrude through the third opening to maximize visibility and ensure uniform light dispersion. The protruding components may be secured using integrated housing features such as clips, snap fits, or mechanical fasteners, and may optionally be sealed with gaskets to maintain the integrity of the enclosure. These variations allow the device to support multiple integration strategies while optimizing sensor functionality and light output based on specific use-case requirements.

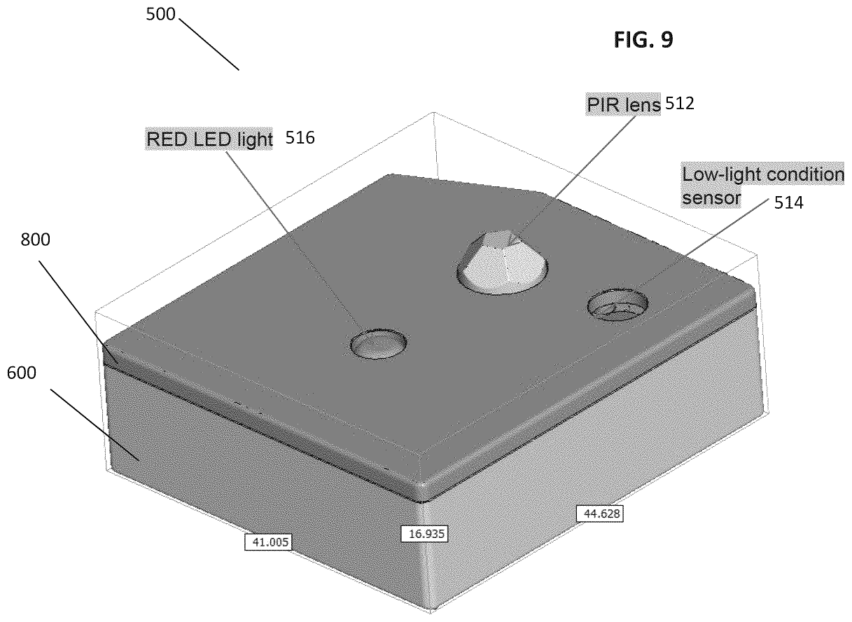

FIG. 9 illustrates the light emitting device 500, as described in FIG. 5, showing a configuration in which one or more sensors are aligned with openings in a cover 800 of the housing 600, in accordance with embodiments of the present disclosure. The housing 600 is shown in an assembled condition, including a housing top 800 secured to a base portion of the housing. The housing encloses internal electronics such as a printed circuit board and a battery (not shown in this view). The top cover 800 includes a plurality of openings to accommodate sensor elements, which are positioned to detect environmental conditions through the housing. A PIR lens 512, forming part of a motion sensor assembly, is protruding through a corresponding opening in the housing top 800. The PIR lens is optically aligned with a passive infrared sensor component located within the housing. The protrusion enables the lens to maintain an unobstructed field of view for detecting motion in the surrounding environment. The lens may be retained using a press-fit or mechanical snap interface with the opening in the housing cover.

Adjacent to the PIR lens 512 is a low-light condition sensor 514, which may be a photodiode, phototransistor, or light-dependent resistor (LDR). The sensor 514 is aligned with a second opening in the housing top 800, which may be transparent or semi-transparent to ambient light wavelengths. The sensor is configured to detect whether the ambient light level is below a predefined threshold suitable for triggering illumination. Also visible is a light emitter 516, such as a red light-emitting diode (LED), which is positioned beneath a third opening in the housing top 800. The LED is configured to emit a low-level illumination sufficient for use as a spatial landmark in dark or low-light environments. The alignment of the LED with the corresponding aperture ensures outward transmission of light through the housing surface. In the illustrated embodiment, each sensor and emitter is functionally positioned to interface with the environment through corresponding apertures or aligned windows in the top surface 800. These openings may be selectively covered with optically transmissive materials or left uncovered depending on design constraints. Notably, the PIR lens 512 visibly extends outward from the plane of the top cover, enhancing motion detection capabilities while distinguishing it physically from the other sensors.

Dimensional annotations shown in the figure indicate the compact size of the sensor housing, which may measure approximately 41 mm×44 mm at the base and approximately 17 mm in height, enabling integration into a flat or low-profile form factor for doorknob-mounted deployment. Accordingly, FIG. 9 illustrates the precise mechanical and optical alignment of the sensor suite within the top cover of the light emitting device housing, and exemplifies an embodiment in which at least one sensor protrudes through an opening in the housing to ensure proper environmental interfacing.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

As used herein, the singular forms “a,” “an,” and “the,” are intended to include the plural forms as well, unless the context clearly indicates otherwise.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, an “embodiment” means that a particular feature, structure or characteristic is included in at least one or more manifestations, examples, or implementations of this invention. Furthermore, the particular features, structures or characteristics may be combined in any suitable manner, as would be apparent to a person having ordinary skill in the art. Combinations of features of different embodiments are meant to be within the scope of the invention, without the need for explicitly describing every possible permutation by example. Thus, any of the claimed embodiments can be used in any combination.

The phrase “and/or,” as used herein in the specification and in the claims, should be understood to mean “either or both” of the elements so conjoined, e.g., elements that are conjunctively present in some cases and disjunctively present in other cases. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements), etc.

As used herein, the word “include,” and its variants, is intended to be non-limiting, such that recitation of items in a list is not to the exclusion of other like items that may also be useful in the compositions and methods of this technology. Similarly, the terms “can” and “may” and their variants are intended to be non-limiting, such that recitation that an embodiment can or may comprise certain elements or features does not exclude other embodiments of the present technology that do not contain those elements or features.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A light emitting device comprising:
a fold-flat foil bag configured to be fitted over and hung upon a doorknob; and
an active component compartment within the fold-flat foil bag having a transparent sensor window, said active component compartment containing:
a LED emitter;
a battery;
a motion detector; and
a light sensor,
wherein said light emitting device is configured to detect motion of a person within five feet during dim lighting conditions and responsive to detecting the motion is further configured to turn on the LED emitter for a short duration, which is less than a minute, after which the LED emitter automatically turns off until reactivated via another instance of motion detection.

2. The light emitting device of claim 1, wherein the LED emitter is a single red LED.

3. The light emitting device of claim 1, wherein the LED emitter is at least one of an orange LED and a yellow LED.

4. The light emitting device of claim 1, wherein an exclusive mechanism to activate the LED emitter is via the motion detector detecting motion while the light sensor is detecting low-lighting conditions, and wherein once activated the LED emitter emits for exactly the short duration.

5. The light emitting device of claim 1, wherein the motion detector and the light sensor are implemented by a single passive infrared (PIR) sensor.

6. The light emitting device of claim 1, wherein the short duration is between ten and thirty seconds.

7. The light emitting device of claim 1, wherein the motion detector is configured to detect motion within a range of less than about ten meters from the light emitting device.

8. The light emitting device of claim 1, wherein the fold-flat foil bag is made of a heat-sealable, printable, transparent material.

9. The light emitting device of claim 1, wherein a top and bottom view of the fold-flat foil bag have an oval shape when used, which fold flat when packaged.

10. The light emitting device of claim 1, wherein a front view of the fold-flat foil bag is rectangularly shaped with a void in a center and a smaller void on one side resulting in a hook shape, such that the light emitting device is configured to be hung on a standard size doorknob and be self-supporting and operational thereafter.

11. A low-light spatial landmark device, comprising:
a housing comprising:
a compartment within the housing, the compartment enclosing a printed circuit board (PCB)
a light emitter disposed on the PCB, the light emitter configured to emit a low-level illumination that is visible in a dark or low-light environment but insufficient to significantly illuminate a surrounding area;
a battery positioned within the housing and electrically coupled to the light emitter;
a motion sensor disposed on the PCB and configured to detect motion within a short-range distance;
a light sensor disposed on the PCB and electrically coupled to the light emitter and the motion sensor; the light sensor configured to detect a low-light condition;
a timer electrically coupled to the motion sensor and the light sensor, wherein the timer activates the light emitter for a pre-defined duration in response to detection of motion and a low-light condition; and
circuitry electrically coupling the battery, light emitter, motion sensor, light sensor, and timer; and
a hanging member comprising:
a substantially radiused edge configured to orient the low-light spatial landmark device in a suspended orientation;
a first opening disposed through the hanging member, the first opening to align with the motion sensor;
a second opening disposed through the hanging member, the second opening to align with the light sensor; and
a third opening disposed through the hanging member, the third opening to align with the light emitter.

12. The low-light spatial landmark device of claim 11, wherein the housing is disposed over a surface of the housing; and
wherein the housing is formed of a heat-sealable, semi-transparent foil material suitable for printing.

13. The low-light spatial landmark device of claim 11, wherein the hanging member comprises a die-cut hook configured to fit over a doorknob.

14. The low-light spatial landmark device of claim 11, wherein the light emitter is a red light-emitting diode (LED).

15. The low-light spatial landmark device of claim 11, wherein the light emitter, motion sensor, light sensor, timer, and circuitry are integrated on a single-sided printed circuit board (PCB).

16. The low-light spatial landmark device of claim 11, wherein the battery is a 23A 12V alkaline battery and is non-replaceable.

17. The low-light spatial landmark device of claim 11, wherein the motion sensor comprises a passive infrared (PIR) sensor having a Fresnel lens with a detection angle of approximately 140 degrees.

18. The low-light spatial landmark device of claim 11, wherein the timer activates the light emitter for a duration of 10 to 20 seconds; and
wherein the light sensor and motion sensor are configured such that the light emitter is only activated when both low-light and motion conditions are satisfied.

19. The low-light spatial landmark device of claim 11, wherein at least one of the first opening of the hanging member, the second opening of the hanging member, or the third opening of the hanging member has a light-transmitting layer of material disposed thereon, the light-transmitting layer of material being transparent or semi-transparent.

20. The low-light spatial landmark device of claim 11, wherein at least one of the motion sensor, the light sensor, or the light emitter protrudes through the first opening, the second opening, or the third opening, respectively.
